(19) United States
(12) Patent Application Publication
(10) Pub. No.: US 2023/0289934 A1
(43) Pub. Date: Sep. 14, 2023

(54) SYSTEMS AND METHODS FOR DISPLAYING IMAGE DATA OF AN OBJECT ON A VIRTUAL ROTATING PLATFORM

(71) Applicant: Glo3D Inc, Toronto (CA)

(72) Inventors: Majid Mobini, Toronto (CA); Seyed Hadi Sadat Toussi, Toronto (CA); Mohammad Mirzaei Hesari, Toronto (CA); Mercedeh Arbab, Toronto (CA)

(73) Assignee: Glo3D Inc, Toronto (CA)

(21) Appl. No.: 18/183,050

(22) Filed: Mar. 13, 2023

Related U.S. Application Data
(60) Provisional application No. 63/269,253, filed on Mar. 12, 2022.
(60) Provisional application No. 63/269,252, filed on Mar. 12, 2022.

(51) Int. Cl. G06T 5/50; G06T 7/194

(52) U.S. Cl. CPC G06T 5/50; G06T 7/194; G06T 2207/20081; G06T 2207/20221

(57) ABSTRACT

An image processing system may obtain image data of an object in an environment included in a first background. The image data includes a plurality of frames, of the object, captured at a plurality of angles. The image processing system may process the plurality of frames to generate a plurality of processed frames. When processing each frame to generate a processed frame includes, the image processing system may generate a first layer using the frame, generate a second layer that includes a second background, remove a portion of the second layer to generate a modified second layer, remove the first background from the frame to generate a third layer that includes the object and a transparent background, and combine the first layer, the modified second layer, and the third layer to generate the processed frame. The image processing system may provide the plurality of processed frames for display.

### RELATED APPLICATION

This application claims priority to U.S. Provisional Pat. Application No. 63/269,253, entitled “SYSTEMS AND METHODS FOR DISPLAYING IMAGE DATA OF AN OBJECT ON A VIRTUAL ROTATING PLATFORM,” filed Mar. 12, 2022, which is incorporated herein by reference in its entirety. This application also claims priority to U.S. Provisional Pat. Application No. 63/269,252, entitled “SYSTEMS AND METHODS FOR DISPLAYING IMAGE DATA OF AN OBJECT ON A VIRTUAL ROTATING GROUND SURFACE,” filed Mar. 12, 2022, which is incorporated herein by reference in its entirety.

### BACKGROUND

A camera is a device that is used to capture image data. For example, the camera may be used to capture a vehicle in an environment. The image data may be processed and displayed via a display device. In some examples, the image data may be a two-dimensional image data.

### SUMMARY

In some implementations, a method performed by a device includes obtaining image data of an object on a surface in a first environment, wherein the first environment includes a first background, and wherein the image data includes a plurality of frames, of the object, captured at a plurality of angles; processing the plurality of frames to generate a plurality of processed frames, wherein processing each frame, of the plurality of frames, to generate a processed frame includes: generating a first layer using the frame, generating a second layer that includes a second background, removing a portion of the second layer to generate a modified second layer, wherein the portion is removed to enable a bottom portion of the object on the surface in the first environment, in the first layer, to be visible through the modified second layer, removing the first background from the frame to generate a third layer that includes the object and a transparent background, and combining the first layer, the modified second layer, and the third layer to generate the processed frame; and providing the plurality of processed frames for display to depict the object rotating, on the surface, in a second environment that includes the second background.

In some implementations, a device includes one or more processors configured to: obtain image data of an object on a surface in an environment, wherein the environment includes a first background, and wherein the image data includes a plurality of frames, of the object, captured at a plurality of angles; process the plurality of frames to generate a plurality of processed frames, wherein, to process each frame, of the plurality of frames, the one or more processors are configured to generate a processed frame includes: generate a first layer using the frame, generate a second layer that includes a second background, remove a portion of the second layer to generate a modified second layer, wherein the portion is removed to enable a bottom portion of the object on the surface, in the first layer, to be visible through the modified second layer, remove the first background from the frame to generate a third layer that includes the object and a transparent background, and combine the first layer, the modified second layer, and the third layer to generate the processed frame; and provide the plurality of processed frames for display.

In some implementations, a non-transitory computer-readable medium storing a set of instructions includes one or more instructions that, when executed by one or more processors of a device, cause the device to: obtain image data of an object in an environment, wherein the environment includes a first background, and wherein the image data includes a plurality of frames, of the object, captured at a plurality of angles; process the plurality of frames to generate a plurality of processed frames, wherein, to process each frame, of the plurality of frames, the one or more processors are configured to generate a processed frame includes: generate a first layer using the frame, remove the first background from the frame to generate a third layer that includes the object and a transparent background, generate a second layer that includes a second background, remove a portion of the second layer to generate a modified second layer, wherein the portion is removed to enable a bottom portion of the object, in the first layer, to be visible through the modified second layer, and combine the first layer, the third layer, and the modified second layer to generate the processed frame; and provide the plurality of processed frames for display.

### BRIEF DESCRIPTION OF THE DRAWINGS

FIGS. 1A-1E are diagrams of an example associated with displaying image data of an object on a virtual rotating platform.

FIG. 2 is a diagram of an example environment in which systems and/or methods described herein may be implemented.

FIG. 3 is a diagram of example components of one or more devices of FIG. 2.

FIG. 4 is a flowchart of an example process relating to displaying image data of an object on a virtual rotating platform.

### DETAILED DESCRIPTION

The following detailed description of example implementations refers to the accompanying drawings. The same reference numbers in different drawings may identify the same or similar elements.

A camera may be used to obtain image data of a 360 degree view of a vehicle. In some situations, the vehicle may be located in a location (or an environment), such as a dealership with a multitude of vehicles. The location, captured in the image data of the 360 degree view of the vehicle, may be undesirable (e.g., due to the multitude of vehicles, a multitude of object, dealership personnel, and/or customers at the location). Additionally, the location may be subject to weather and environmental conditions such as sun, rain, wind, and/or dust, among other examples. Such environmental conditions may negatively affect a depiction of the vehicle in the image, thereby affecting a measure of quality of the image data.

In order to address issues related to the location and the weather and environmental conditions, the vehicle may be moved to a different location, such as a showroom. The camera may be used to obtain, a second time, image data of a 360 degree view of the vehicle. Furthermore, one or more additional devices may be used to improve a measure of quality of the image data. For example, one or more devices may be used to control a lighting of the vehicle. Moreover, the image data may be processed by one or more computing devices to adjust the lighting of the vehicle.

Based on the foregoing, obtaining image data of a 360 degree view of the vehicle in this manner may be a time consuming process due to the vehicle being relocated to different locations, due to the image data of the 360 degree view being captured multiple times, and/or due to the image data being processed by the one or more computing devices. Accordingly, obtaining the image data of the 360 degree view of the vehicle in this manner may consume computing resources (to process the image data), storage resources (to store multiple versions of the image data), network resources (to transmit the image data to the one or more computing devices), among other resources.

Implementations described herein are directed to enable a system for providing a 360 degree view of an object on a virtual rotating platform (or a virtual turntable) in a selectable environment (or a selectable background). The system may include a camera configured to capture image data of a 360 degree view of the object in a first background and include one or more computing devices for processing the image data. The first background may include a first background that is to be replaced with a second background (e.g., the selectable background). In some examples, the camera may be included in another device, such as a mobile device (e.g., a cellular phone, a tablet, a laptop, among other examples). In some situations, the one or more computing devices may be implemented in a cloud computing environment. In some implementations, the object may include a motorized machine, such as a vehicle, an aircraft, a watercraft, among other examples.

In some implementations, the camera may obtain the image data. For example, the image data may be obtained by moving the camera around the object and capturing images for the 360 degree view of the object on a surface in the first environment. Additionally, or alternatively, the image data may be obtained by moving the camera around the object and capturing a video for the 360 degree view of the object on the surface in the first environment. The surface may include a ground surface.

In some instances, the object may be provided on a rotating platform (e.g., a turntable). In this regard, the image data may be obtained by rotating the object on the turntable and capturing images for the 360 degree view of the object as the object is rotated. Additionally, or alternatively, the image data may be obtained by rotating the object on the turntable and capturing a video for the 360 degree view of the object as the object is rotated.

The one or more computing devices may process the image data. In some implementations, the one or more computing devices may include the device that includes the camera. The image data may include multiple frames captured in a particular order. In this regard, the one or more computing devices may process each frame of the multiple frames.

For example, for each frame, the one or more computing devices may generate multiple layers and combine the multiple layers to generate a processed frame. A layer, as used herein, may refer to a layer of an image. As an example, the one or more computing devices may generate a first layer based on the frame. The one or more computing devices may select an image of the second background and may use the second background to generate a second layer. The one or more computing devices may remove a portion of the second layer to generate a modified second layer.

The portion of the second layer may be removed to enable a bottom portion of the object on the surface, in the first environment in the first layer, to be visible through the modified second layer when the first layer and a third layer are combined. The one or more computing devices may generate the third layer by removing a background of the frame. In the regard, the third layer may include the object (remaining after the background has been removed) with a transparent background.

In some implementations, the one or more computing devices may generate the processed frame by combining the first layer, the modified second layer, and the third layer. For example, the one or more computing devices may provide the modified second layer on the first layer, and may provide the third layer on the modified second layer. The modified second layer may enable the bottom portion of the object on the surface, in the first environment in the first layer, to be visible through the modified second layer when the first layer and a third layer are combined. Accordingly, the processed frame may depict the object, on the surface, in a second environment that includes the second background.

The one or more computing devices may perform similar operations for other frames of the multiple frames to generate processed frames. The processed frames may be provided for display. By providing the processed frames for display, the one or more computing devices may depict the object rotating the virtual rotating platform. In other words, the one or more computing devices may depict the object rotating, on the surface, in the second environment that includes the second background.

As result of providing the 360 degree view of the object on the virtual rotating platform in the manner described herein, the system may preserve computing resources, storage resources, network resources, among other resources, that would have been consumed by obtaining image data of the existing state of the art.

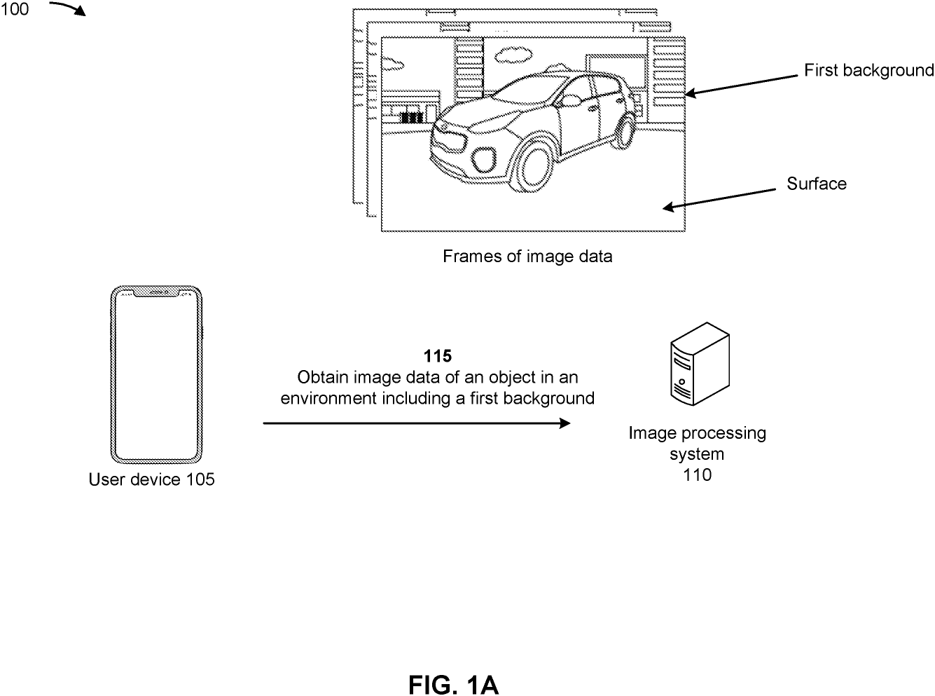

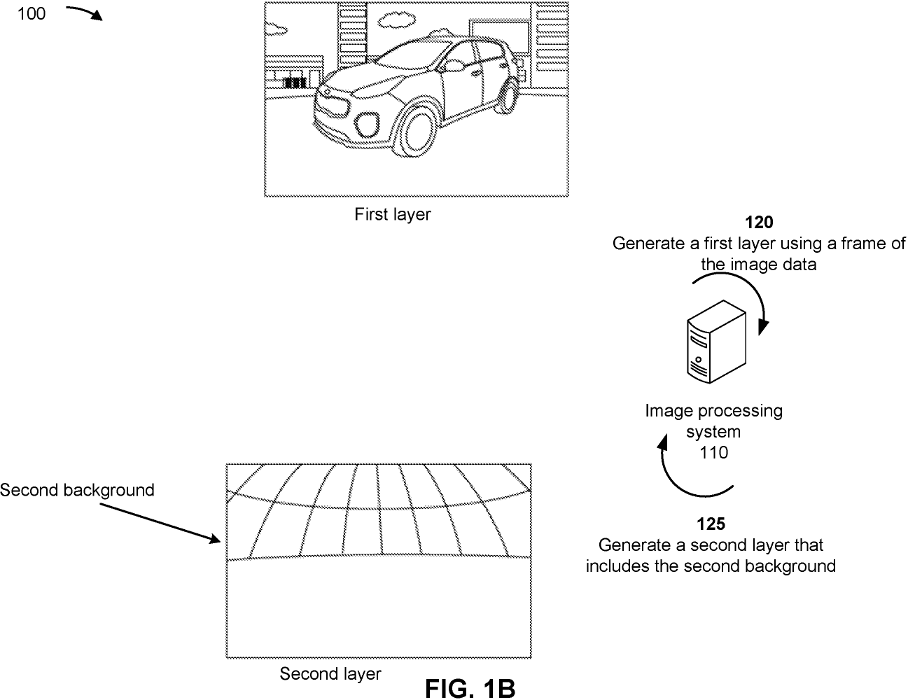

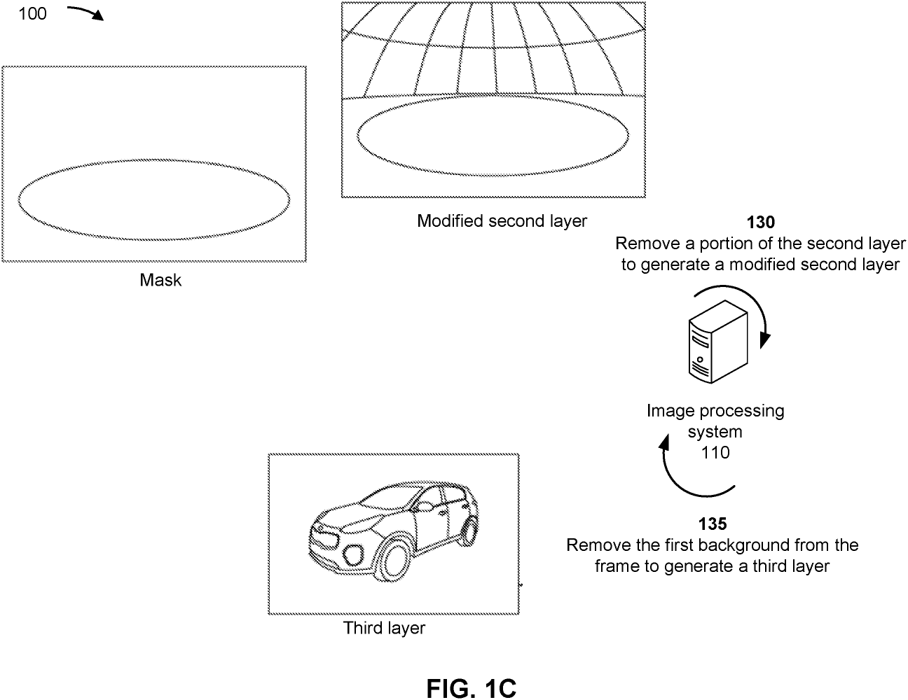

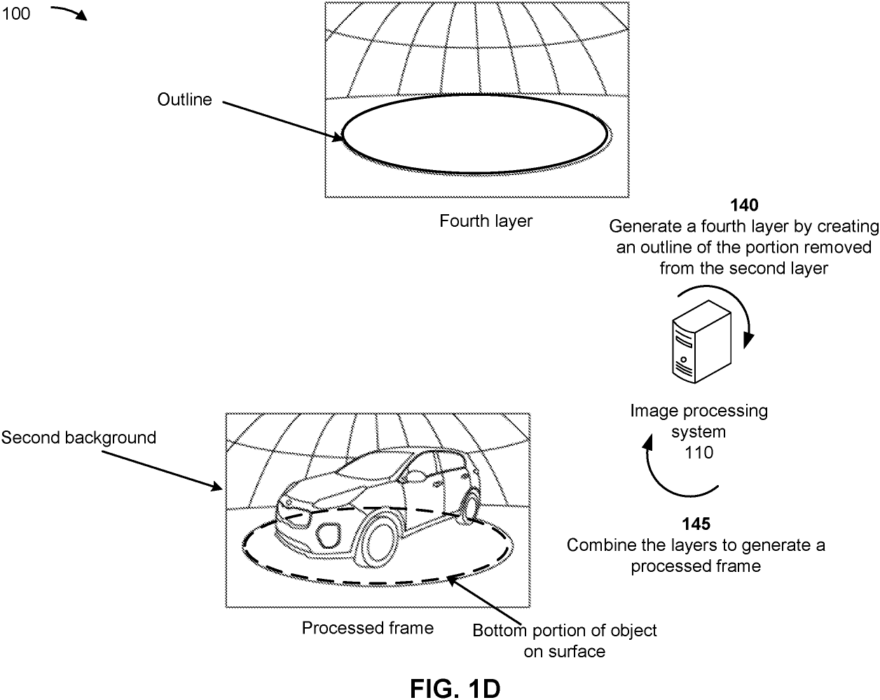

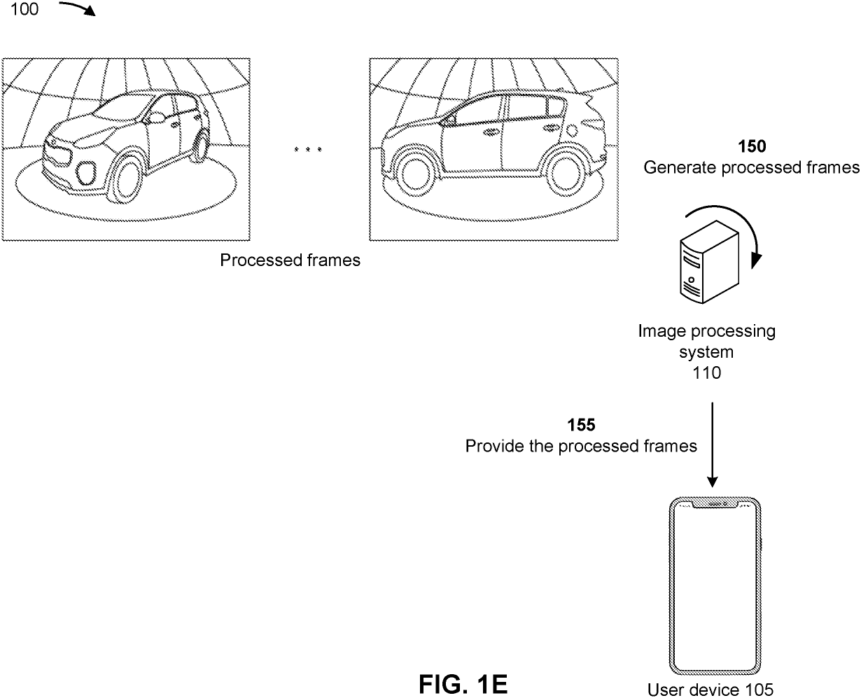

FIGS. 1A-1E are diagrams of an example 100 associated with displaying image data of an object on a virtual rotating platform. As shown in FIGS. 1A-1E, example 100 includes a user device 105 and an image processing system 110.

User device 105 includes one or more devices capable of receiving, generating, storing, processing, and/or providing information associated with displaying image data of an object on a virtual rotating platform, as described elsewhere herein. In some examples, user device 105 may be configured to capture image data and provide the image data to image processing system 110 for processing.

User device 105 may include a communication device and a computing device. For example, user device 105 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

Image processing system 110 may include one or more devices (e.g., computing devices) capable of receiving, generating, storing, processing, and/or providing information associated with displaying image data of an object on a virtual rotating platform, as described elsewhere herein. Image processing system 110 may be configured to process image data using one or more image processing techniques.

In some situations, image processing system 110 may be implemented in a cloud computing environment. Alternatively, image processing system 110 may be implemented in a computing environment different than a cloud computing environment. In some implementations, image processing system 110 may use a machine learning algorithm to process the image data. The machine learning algorithm may include fast region based-CNN (R-CNN), faster R-CNN, region-based fully convolutional network (R-FCN), single shot detector (SSD), YOLO (you only look once), among other examples.

As shown in FIG. 1A, and by reference number 115, image processing system 110 may obtain image data of an object in an environment including a first background. For example, user device 105 may capture the image data of the object on a surface in the environment and image processing system 110 may provide the image data to user device 105. User device 105 may capture images that form a 360 degree view of the object. In some situations, user device 105 may provide the image data with a request to process the image data to generate a 360 degree view of the object on a virtual rotating platform (or a virtual turntable) in a particular environment that includes a second background.

In some implementations, the request may include information identifying the particular environment or the second background. The image data may include a plurality of frames. Each frame may include a different angle of the object in the environment. In other words, the image data includes the plurality of frames, of the object, captured at a plurality of angles. The plurality of frames may be captured in a particular order.

As shown in FIG. 1A, for example, the object may include a motorized machine, such as a vehicle, an aircraft, and/or a watercraft, among other examples. As further shown in FIG. 1A, for example, the motorized machine may be provided at a dealership. While the example described herein refers to a motorized machine, the object may include different types of objects, such as a piece of furniture, a building, a device, and/or a plant, among other examples

As shown in FIG. 1B, and by reference number 120, image processing system 110 may generate a first layer using a frame of the image data. For example, image processing system 110 may select the frame from the plurality of frames of the image data. In some instances, the frame may be a first frame in the particular order of the plurality of frames, may be a last frame in the particular order of the plurality of frames, may be a frame other than the first frame or the last frame.

As shown in FIG. 1B, and by reference number 125, image processing system 110 may generate a second layer that includes the second background. For example, image processing system 110 may select an image of the second background and may use the image of the second background to generate the second layer. In some implementations, the image of the second background may be included in the request received from user device 105.

Additionally, or alternatively, the request may include information identifying the second background. In this regard, image processing system 110 may perform a search using the information identifying the second background. Image processing system 110 may identifying the image of the second background based on performing the search. For example, the information identifying the second background may include one or more keywords that identify the second background. Image processing system 110 may use the keywords to search one or more repositories of images. The one or more repositories may include one or more storage devices.

As shown in FIG. 1C, and by reference number 130, image processing system 110 may remove a portion of the second layer to generate a modified second layer. For example, image processing system 110 may remove the portion of the second layer to enable a bottom portion of the object on the surface, in the first layer, to be visible through the modified second layer when the first layer, the modified second layer, and/or the third layer are combined.

Image processing system 110 may use one or more image processing techniques to analyze the first layer to identify a position of the bottom portion of the object in the first layer. Image processing system 110 may use one or more image processing techniques to analyze the second layer and identify the portion of the second layer based on the position of the bottom portion of the object in the first layer. For example, the portion of the second layer may be based on the position of the bottom portion of the object in the first layer.

In some implementations, image processing system 110 may apply a mask on the second layer to remove the portion of the second layer. In some situations, the portion, of the second layer, may be a geometric shape. For example, as shown in FIG. 1C, the portion may be an oval shape. Alternatively, the portion may be a circular shape, a semi-circular shape, among other geometric shapes. When applying the mask, image processing system 110 may remove an area delimited by the geometric shape.

As shown in FIG. 1C, and by reference number 135, image processing system 110 may remove the first background from the frame to generate a third layer. For example, image processing system 110 may remove the first background from the frame by analyzing the frame to identify the object (e.g., identify an area that includes the object). Image processing system 110 may remove all content, from the third layer, that is not part of the object. For example, image processing system 110 may change colors of pixels that are not included in the area that includes the object.

In some implementations, image processing system 110 may generate the third layer by removing the first background of the frame. In this regard, the third layer may include the object (remaining after the first background has been removed) with a transparent background. In some examples, the first background may be removed using a machine learning algorithm (or an artificial intelligence algorithm), such as a Convolutional Neural Networks (CNN). In some situations, the transparent background may be provided in a Portable Network Graphics (PNG) format, in a WebP formation, among other formats associated with transparency.

In some situations, image processing system 110 may determine a contour (or an outline) of the object in the third layer. For example, image processing system 110 may use a machine learning algorithm to determine the contour. The machine learning algorithm may include fast region based-CNN (R-CNN), faster R-CNN, region-based fully convolutional network (R-FCN), single shot detector (SSD), YOLO (you only look once), among other examples.

In some implementations, when determining the contour, image processing system 110 may analyze the first layer to determine a difference between the transparent background and the object. Additionally, or alternatively, image processing system 110 may determine a difference between a pixelated area of the first layer and a non-pixelated area of the first layer. The pixelated area may outline the contour of the object.

In some implementations, image processing system 110 may use the contour of the object to remove the first background. For example, image processing system 110 may remove all content that is not included in an area defined by the contour.

In some implementations, image processing system 110 may use the contour of the object to adjust a position of the object in the first layer and/or to adjust a size of the object in the first layer. In this regard, the position of the object and/or the size of the object may be adjusted in order to provide a uniform position of the object and/or a uniform size of the object from one frame to another frame as the plurality of frames (after being processed) are provided for display.

For example, image processing system 110 may adjust a position of the object to maintain the object in a same position (or a same location) from one processed frame to another frame, thereby preventing the object from jumping from one location (e.g., vertical position and/or horizontal position) to another location (e.g., vertical position and/or horizontal position). Additionally, the object may be resized to prevent the object from being one size in one frame and being another size in another frame (e.g., large in one frame and small in another frame).

As shown in FIG. 1D, and by reference number 140, image processing system 110 may generate a fourth layer by creating an outline of the portion removed from the second layer. In some implementations, generate the fourth layer by creating an outline of a geometric shape of the portion removed from the second layer. Generating the fourth layer may be optional. In some implementations, a thickness (or a width) of the outline may vary. In some implementations, the outline may include different patterns, different colors, among other examples. In some situations, the thickness, the patterns, and/or the colors may be identified in the request.

As shown in FIG. 1D, and by reference number 145, image processing system 110 may combine the layers to generate a processed frame. For example, image processing system 110 may provide the modified second layer on the first layer and provide the third layer on the modified second layer. As shown in FIG. 1D, the modified second layer may enable the bottom portion of the object on the surface in the first layer to be visible through the modified second layer. Accordingly, the processed frame may depict the object, on the surface, in another environment that includes the second background.

In some implementations, if the fourth layer is generated, image processing system 110 may provide the fourth layer between the modified second layer and the first layer, provide the fourth layer between the first layer and the modified second layer, or provide the fourth layer on the third layer.

As shown in FIG. 1E, and by reference number 150, image processing system 110 may generate processed frames. For example, image processing system 110 may process other frames, of the plurality of frames, in a manner similar to the manner described above in connection with FIGS. 1A-1D. Image processing system 110 may process the plurality of frames to generate the processed frames.

In some situations, image processing system 110 may use the contour of the object to adjust a position of the object in the first layer and/or to adjust a size of the object in the first layer. In this regard, the position of the object and/or the size of the object may be adjusted in order to provide a uniform position of the object and/or a uniform size of the object from one frame to another frame as the multiple frames are provided for display, as explained. In some implementations, image processing system 110 may determine a size of the object and a position of the object in a first frame processed by image processing system 110 and may ensure that a size of the object and a position of the object in other frames match the size of the object and the position of the object in the first frame processed by image processing system 110.

As shown in FIG. 1E, and by reference number 155, image processing system 110 may provide the processed frames. For example, after generating the processed frames, image processing system 110 may provide the processed frames to user device 105. Additionally, or alternatively, image processing system 110 may provide the processed frames to one or more additional devices.

In some implementations, the processed frames may be provided for display in the particular order in which the frames were provided to image processing system 110. Alternatively, the frames may be provided in a reverse order with respect to the particular order. In some examples, the processed frames may be provided in the particular order or in the reverse order based on interaction on a display of user device 105 (e.g., an interaction by way of a movement of a finger on the display). The movement may include a swap movement, a tap, and/or a sliding movement, among other examples.

Additionally, or alternatively, the processed frames may be provided in the particular order or in the reverse order based on interaction using an input device associated with user device 105 (e.g., a mouse., a mousepad, a keyboard, and/or a microphone, among other examples).

In some implementations, image processing system 110 may cause a portion of the processed frames to be provided to user device 105 in an effort to expedite a manner in which the processed frames are provided for display by user device 105. Alternatively, image processing system 110 may adjust a resolution of the processed frames based on a processing capabilities of user device 105. For example, image processing system 110 may decrease the resolution of the processed frames based on determining that the processing capabilities do not satisfy a processing capability threshold. Alternatively, image processing system 110 may increase the resolution of the processed frames based on determining that the processing capabilities satisfy the processing capability threshold.

While the foregoing example has been described in connection with image processing system 110 processing the image data, in some implementations, user device 105 may process the image data in a manner that the manner in which image processing system 110 processed the image data. In some implementations, image processing system 110 may perform a first portion of the processing of the image data while user device 105 may perform a second portion of the portion of the processing of the image data. For example, image processing system 110 may generate the layers and user device 105 may combine the layers to generate the processed frames.

As result of providing the 360 degree view of the object on the virtual rotating platform in the manner described herein, ii may preserve computing resources, storage resources, network resources, among other resources, that would have been consumed by obtaining image data of the existing state of the art.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

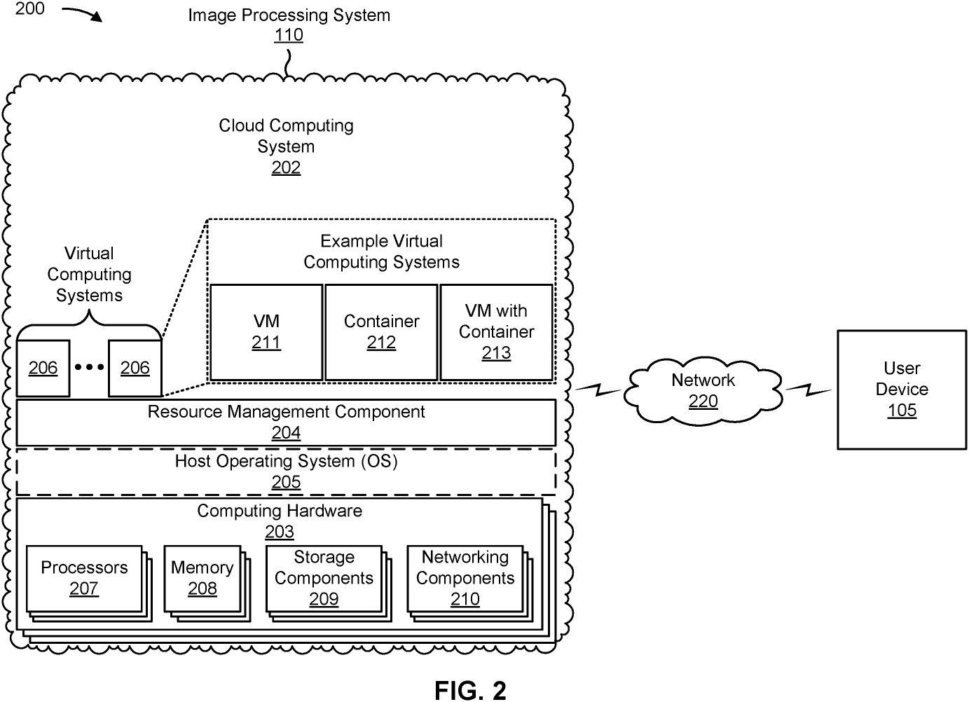

FIG. 2 is a diagram of an example environment 200 in which systems and/or methods described herein may be implemented. As shown in FIG. 2, environment 200 may include image processing system 110, which may include one or more elements of and/or may execute within a cloud computing system 202. The cloud computing system 202 may include one or more elements 203-213, as described in more detail below. As further shown in FIG. 2, environment 200 may include user device 105 and a network 220. Devices and/or elements of environment 200 may interconnect via wired connections and/or wireless connections.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 includes hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine 211, a container 212, or a hybrid environment 213 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

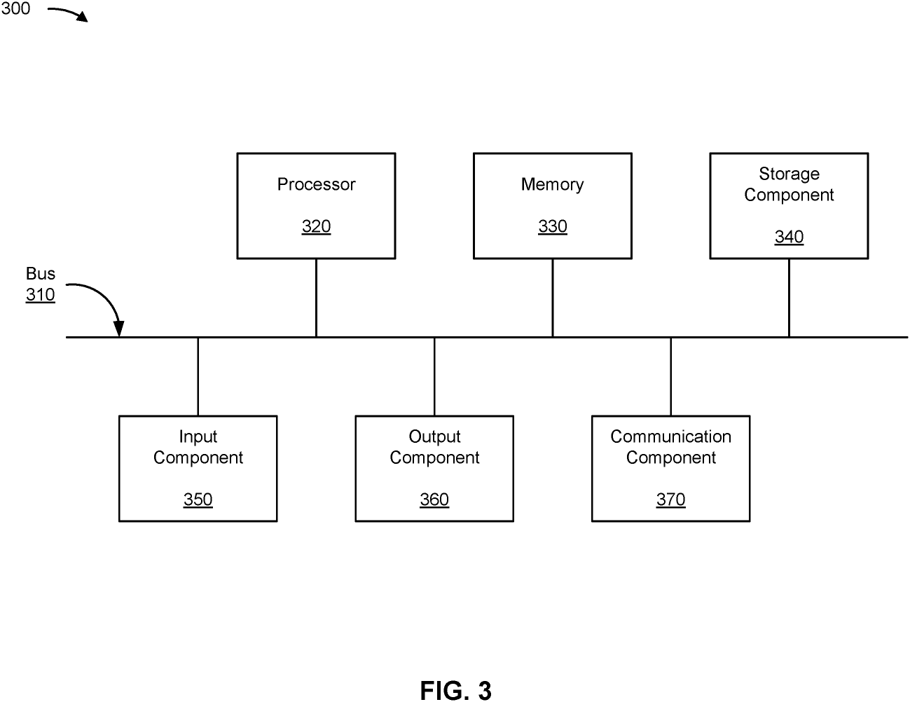

Although image processing system 110 may include one or more elements 203-213 of the cloud computing system 202, may execute within the cloud computing system 202, and/or may be hosted within the cloud computing system 202, in some implementations, image processing system 110 may not be cloud-based (e.g., may be implemented outside of a cloud computing system) or may be partially cloud-based. For example, image processing system 110 may include one or more devices that are not part of the cloud computing system 202, such as device 300 of FIG. 3, which may include a standalone server or another type of computing device. Image processing system 110 may perform one or more operations and/or processes described in more detail elsewhere herein.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

User device 105 has been described above. In some implementations, user device 105 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. User device 105 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to image processing system 110 and/or user device 105. In some implementations, image processing system 110 and/or user device 105 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

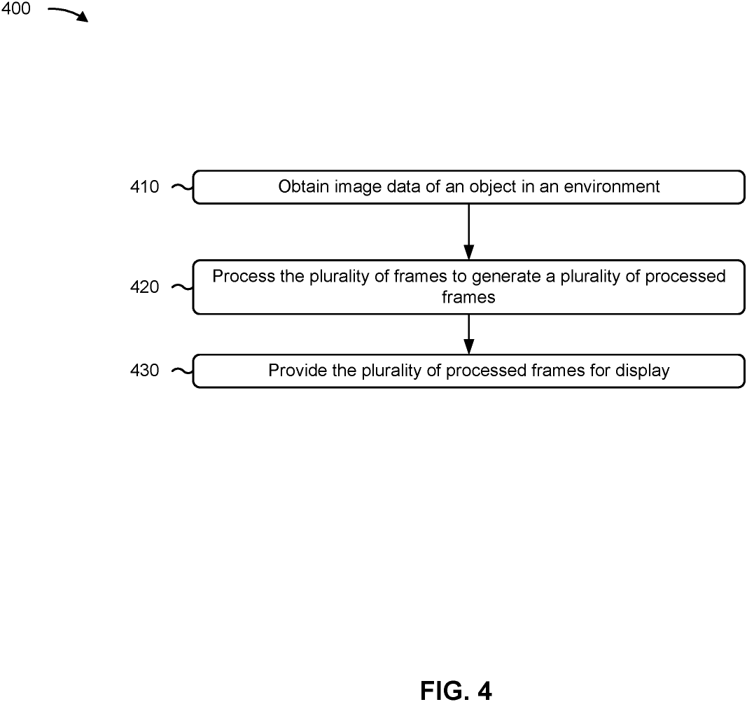

FIG. 4 is a flowchart of an example process 400 relating to displaying image data of an object on a virtual rotating platform. In some implementations, one or more process blocks of FIG. 4 may be performed by image processing system 110 (e.g., image processing system 110). In some implementations, one or more process blocks of FIG. 4 may be performed by another device or a group of devices separate from or including the device, such as a user device (e.g., user device 105). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include obtaining image data of an object in an environment (block 410). For example, the device may obtain image data of an object on a surface in a first environment. The first environment includes a first background, and wherein the image data includes a plurality of frames, of the object, captured at a plurality of angles, as described above. In some implementations, the environment includes a first background. In some implementations, the image data includes a plurality of frames, of the object, captured at a plurality of angles.

As further shown in FIG. 4, process 400 may include processing the plurality of frames to generate a plurality of processed frames (block 420). For example, the device may process the plurality of frames to generate a plurality of processed frames, as described herein. Processing each frame, of the plurality of frames, to generate a processed frame includes: generating a first layer using the frame, generating a second layer that includes a second background, removing a portion of the second layer to generate a modified second layer, removing the first background from the frame to generate a third layer that includes the object and a transparent background, and combining the first layer, the modified second layer, and the third layer to generate the processed frame, as described above. The portion is removed to enable a bottom portion of the object on the surface in the first environment, in the first layer, to be visible through the modified second layer.

As further shown in FIG. 4, process 400 may include providing the plurality of processed frames for display (block 430). For example, the device may provide the plurality of processed frames for display to depict the object rotating, on the surface, in a second environment that includes the second background, as described above.

Process 400 may include additional implementations, such as any single implementation or any combination of implementations described below and/or in connection with one or more other processes described elsewhere herein.

In a first implementation, combining the first layer, the modified second layer, and the third layer comprises providing the modified second layer on the first layer, and providing the third layer on the modified second layer.

In a second implementation, removing the portion of the second layer comprises removing content included in the portion, or applying a mask to the portion.

In a third implementation, process 400 includes determining a contour of the object in the first layer, and basing on the contour, adjusting one or more of a size of the object, or a position of the object.

In a fourth implementation, determining the contour of the object comprises analyzing the first layer to determine a difference between the transparent background and the object, or determining a difference between a pixelated area of the first layer and a non-pixelated area of the first layer.

In a fifth implementation, determining the contour of the object comprises analyzing the first layer, using a machine learning algorithm, to determine the contour of the vehicle.

In a sixth implementation, the plurality of frames are captured in a particular order, and wherein providing the plurality of frames includes at least one of providing the plurality of frames in the particular order, or providing the plurality of frames in a reverse order with respect to the particular order.

In a seventh implementation, process 400 includes generating a fourth layer by creating an outline of the portion removed from the second layer, and combining the fourth layer with the first layer, the third layer, and the modified second layer to generate the processed frame.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a device, the method comprising:
obtaining image data of an object on a surface in a first environment,
wherein the first environment includes a first background, and
wherein the image data includes a plurality of frames, of the object, captured at a plurality of angles;
processing the plurality of frames to generate a plurality of processed frames,
wherein processing each frame, of the plurality of frames, to generate a processed frame includes:
generating a first layer using the frame,
generating a second layer that includes a second background,
removing a portion of the second layer to generate a modified second layer,
wherein the portion is removed to enable a bottom portion of the object on the surface in the first environment, in the first layer, to be visible through the modified second layer,
removing the first background from the frame to generate a third layer that includes the object and a transparent background, and
combining the first layer, the modified second layer, and the third layer to generate the processed frame; and
providing the plurality of processed frames for display to depict the object rotating, on the surface, in a second environment that includes the second background.

2. The method of claim 1, wherein combining the first layer, the modified second layer, and the third layer comprises:
providing the modified second layer on the first layer; and
providing the third layer on the modified second layer.

3. The method of claim 1, wherein removing the portion of the second layer comprises:
removing content included in the portion; or
applying a mask to the second layer.

4. The method of claim 1, further comprising:
determining a contour of the object in the first layer; and
based on the contour, adjusting one or more of:
a size of the object, or
a position of the object.

5. The method of claim 4, wherein determining the contour of the object comprises:
analyzing the first layer to determine a difference between the transparent background and the obj ect; or
determining a difference between a pixelated area of the first layer and a non-pixelated area of the first layer.

6. The method of claim 4, wherein determining the contour of the object comprises:
analyzing the first layer, using a machine learning algorithm, to determine the contour of the object.

7. The method of claim 1, wherein the plurality of frames are captured in a particular order, and
wherein providing the plurality of frames includes at least one of:
providing the plurality of frames in the particular order, or
providing the plurality of frames in a reverse order with respect to the particular order.

8. The method of claim 1, further comprising:
generating a fourth layer by creating an outline of the portion removed from the second layer; and
combining the fourth layer with the first layer, the third layer, and the modified second layer to generate the processed frame.

9. A device, comprising:
one or more processors configured to:
obtain image data of an object on a surface in an environment,
wherein the environment includes a first background, and
wherein the image data includes a plurality of frames, of the object, captured at a plurality of angles;
process the plurality of frames to generate a plurality of processed frames,
wherein, to process each frame, of the plurality of frames, the one or more processors are configured to generate a processed frame includes:
generate a first layer using the frame,
generate a second layer that includes a second background,
remove a portion of the second layer to generate a modified second layer,
wherein the portion is removed to enable a bottom portion of the object on the surface, in the first layer, to be visible through the modified second layer,
remove the first background from the frame to generate a third layer that includes the object and a transparent background, and
combine the first layer, the modified second layer, and the third layer to generate the processed frame,
wherein the processed frame depicts the object, with the second background, on the surface; and
provide the plurality of processed frames for display.

10. The device of claim 9, wherein the one or more processors are further configured to:
generate a fourth layer by creating an outline of a geometric shape of the portion of the second layer; and
combine the fourth layer with the first layer, the third layer, and the modified second layer to generate the processed frame.

11. The device of claim 9, wherein the one or more processors, to remove the portion of the second layer, are configured to:
remove content included in the portion; or
apply a mask to the second layer.

12. The device of claim 9, wherein the one or more processors, to combine the first layer, the modified second layer, and the third layer, are configured to:
provide the modified second layer on the first layer; and
provide the third layer on the modified second layer.

13. The device of claim 9, wherein the one or more processors, to remove the portion of the second layer, are configured to:
determine a contour of the object in the first layer; and
based on the contour, adjust one or more of:
a size of the object, or
a position of the object.

14. The device of claim 13, wherein the one or more processors, to determine the contour of the object, are configured to:
analyze the first layer, using a machine learning algorithm, to determine the contour of the object.

15. A non-transitory computer-readable medium storing a set of instructions, the set of instructions comprising:
one or more instructions that, when executed by one or more processors of a device, cause the device to:
obtain image data of an object in an environment,
wherein the environment includes a first background, and
wherein the image data includes a plurality of frames, of the object, captured at a plurality of angles;
process the plurality of frames to generate a plurality of processed frames,
wherein, to process each frame, of the plurality of frames, the one or more processors are configured to generate a processed frame includes:
generate a first layer using the frame,
remove the first background from the frame to generate a third layer that includes the object and a transparent background,
generate a second layer that includes a second background,
remove a portion of the second layer to generate a modified second layer,
wherein the portion is removed to enable a bottom portion of the object, in the first layer, to be visible through the modified second layer, and
combine the first layer, the third layer, and the modified second layer to generate the processed frame; and
provide the plurality of processed frames for display.

16. The non-transitory computer-readable medium of claim 15, wherein the one or more instructions, when executed by the one or more processors, further cause the device to:
determine a contour of the object in the first layer; and
based on the contour, adjust one or more of:
a size of the object, or
a position of the object.

17. The non-transitory computer-readable medium of claim 16, wherein the one or more instructions, that cause the device to determine the contour of the object, cause the device to:
analyze the first layer, using a machine learning algorithm, to determine the contour of the object.

18. The non-transitory computer-readable medium of claim 15, wherein the one or more instructions, that cause the device to remove the portion of the second layer, cause the device to:
remove content included in the portion; or
apply a mask to the second layer.

19. The non-transitory computer-readable medium of claim 15, wherein the one or more instructions, that cause the device to combine the first layer, the modified second layer, and the third layer, cause the device to:
provide the modified second layer on the first layer; and
provide the third layer on the modified second layer.

20. The non-transitory computer-readable medium of claim 15, wherein the one or more instructions, when executed by the one or more processors, further cause the device to:
generate a fourth layer by creating an outline of a geometric shape of the portion of the second layer; and
combine the fourth layer with the first layer, the third layer, and the modified second layer to generate the processed frame.
